(19) United States
(12) Patent Application Publication
(10) Pub. No.: US 2011/0277380 A1
(43) Pub. Date: Nov. 17, 2011

(54) TREATMENT OF LOW RANK COALS

(75) Inventor: Louis Wibberley, Garden Suburb (AU)

(73) Assignee: COMMONWEALTH SCIENTIFIC AND INDUSTRIAL RESEARCH ORGANISATION, Campbell, Australian Capital Territory (AU)

(21) Appl. No.: 13/144,233

(22) PCT Filed: Jan. 13, 2010
(86) PCT No.: PCT/AU2010/000026

§ 371 Date: Jul. 12, 2011

(30) Foreign Application Priority Data
Jan. 13, 2009 (AU) 2009900122
Feb. 19, 2009 (AU) 2009900708

(51) Int. Cl. C10L 5/00; B01J 19/00

(52) U.S. Cl. 44/505; 422/162

(57) ABSTRACT

A process for treating coal in which coal, in the form of particles in an aqueous slurry, is heated under pressure to at least partially release bound water from the coal particles, the bound water being released as liquid water. In one aspect, the coal particles of the slurry are hydraulically milled by means of the slurry water as the slurry pressure is reduced through the milling. In a second aspect, mineral and/or inorganic content is separated from the slurry by a flotation procedure that utilizes bubbling of released gases following reduction of the slurry pressure. Also disclosed is corresponding apparatus.

### FIELD OF THE INVENTION

This invention is an improved method for processing coals, especially but not exclusively lower rank coals such as Victorian brown coals or Indonesian or German lignites. The process includes hydrothermal treatment, and in an advantageous application can be employed to produce a slurry that is adaptable as a fuel for diesel or other internal combustion engines. Such a fuel, sometimes referred to as a coal water slurry fuel (CWF), could also be used for other combustion devices such as boilers and kilns requiring low ash liquid fuel.

### BACKGROUND OF THE INVENTION

There is rapidly growing pressure for stationary sources of CO₂ emissions such as power stations, to make step reductions in greenhouse has (GHG) emissions. One method of achieving this is by increasing the thermal efficiency of coal utilization.

For conventional technology, involving pulverized fuel firing of boilers with low rank coals, this usually involves reducing the water content of the coal prior to combustion. One method of partially dewatering coal is by hydrothermal treatment. A schematic of the process is shown in FIG. 1.

In the conventional hydrothermal dewatering process shown in FIG. 1, low rank coal 10 is milled 12 to typically −1 mm, and then mixed with water 14 in a slurry tank 16 to produce a pumpable slurry 18. The slurry is pressurized 20 and heated 22 and held in a hydrothermal reactor 24 (typically at 250-350° C. and at a pressure above the saturation pressure to prevent boiling) for a period of around 20-30 minutes. After heating, the slurry is cooled 26, the pressure is reduced 28 and the gases evolved during the treatment, e.g. CO₂, are removed in a separator 30. The slurry is dewatered as much as is practical using a centrifuge 34 and/or thickeners 36. The slurry is typically then milled further (not shown) to achieve a product slurry 40 with a coal particle size distribution suitable for combustion. Although the product coal 40 is a thick slurry, its water content is usually at least 10% lower than the raw feed coal, and this results in an increase in thermal efficiency of boilers and similar combustion devices. The main advantage of the hydrothermal process is that the coal water is removed as a liquid, which avoids the latent heat losses that would occur if the same amount of water was removed by drying.

The process of hydrothermal treatment causes a number of dehydration and decarboxylation reactions to occur in the coal, which liberates (chemically) bound water and some carbon dioxide (via the decomposition of hydroxide and carboxyl groups). As these reactions involve decomposition of hydrophilic groups, the coal becomes more hydrophobic, and the rank of the coal is essentially increased.

It is an object of the present invention to improve the energy efficiency of the aforedescribed process, and/or to improve the quality and suitability of the fuel for diesel engines.

It is not admitted that any of the information in this specification is common general knowledge, or that the person skilled in the art could reasonably be expected to have ascertained, understood, regarded it as relevant or combined it in any way at the priority date.

### SUMMARY OF THE INVENTION

In a first aspect of the invention, instead of letting down the pressure of the slurry from the hydrothermal reactor and separating out dissolved gases to waste, the coal particles of the slurry are hydraulically milled, preferably micronized, by means of the slurry water as the slurry pressure is released.

In its first aspect, the invention provides a process for treating coal in which the coal, in the form of particles in an aqueous slurry, is heated under pressure to at least partially release bound water from the coal particles, the bound water being released as liquid water. The coal particles of the slurry are hydraulically milled, and preferably micronized, by means of the slurry water as the slurry pressure is reduced through the milling.

In an application of the process to coal dewatering, the slurry, after cooling and the hydraulic milling, is treated to separate out at least a portion of the total liquid water of the slurry.

The invention further provides, in its first aspect, apparatus for treating coal, comprising: a hydrothermal reactor arrangement for heating coal, in the form of particles in an aqueous slurry, under pressure to at least partially release bound water from the coal particles, the bound water being released as liquid water, and hydraulic mill means to receive the slurry from the hydrothermal reactor and to hydraulically mill, preferably micronise, the coal particles of the slurry by means of the slurry water as the slurry pressure is reduced through the mill means.

The apparatus may further include means to cool the slurry and means to treat the slurry after said cooling and said hydraulic milling to separate out at least a portion of the total liquid water of the slurry.

The hydraulic milling may be effected in a hydraulic jet mill or similar device. This can reduce the energy consumption for the overall process by around 40 kWh/t coal (dry basis) and decrease equipment cost by reducing the amount of micronising otherwise required by the use of conventional mills. Hydraulic micronising also increases the liberation of mineral matter due to the high shear and hydraulic forces acting on the particles, together with shock and cavitation effects. The increased liberation from micronising and other milling effects also increase the effectiveness of the subsequent cleaning stage.

In a second aspect of the invention, mineral and/or inorganic content is separated from the slurry by a flotation procedure that utilises bubbling of gas released following reduction of the slurry pressure.

In its second aspect, the invention provides a process for treating coal in which the coal, in the form of particles in an aqueous slurry, is heated under pressure to at least partially release gases and bound water from the coal particles, the bound water being released as liquid water. Mineral and/or inorganic content is separated from the slurry by a flotation procedure that utilises bubbling of the released gases following reduction of the slurry pressure.

The invention further provides, in its second aspect, apparatus for treating coal, comprising: a hydrothermal reactor arrangement for heating coal, in the form of particles in an aqueous slurry, under pressure to at least partially release gases and bound water from the coal particles, the bound water being released as liquid water; and a flotation separator to receive the slurry from the hydrothermal reactor rearrangement and to separate mineral and/or inorganic content from the slurry by a flotation procedure that utilises bubbling of said released gases following reduction of the slurry pressure.

Preferably, both aspects of the invention are employed in a coal treatment process, and the second aspect is most preferably employed after micronising of the coal according to the first aspect.

Advantageously, the flotation procedure is effective to float the coal particles. Bubbling of the released gas (mostly CO₂) following reduction of the slurry pressure, e.g. by controlled evolution of the dissolved gases (mostly CO₂), can provide 35% or more of the gas bubbles required to separate the coal, which reduces the power consumption for flotation by reducing the work for producing fine bubbles by pumping or air compression. The rate of CO₂ evolution can be determined by controlling the temperature of flotation, cell depth, cell over pressure, together with ultrasonics and other techniques used to stimulate nucleation of gas bubbles in liquids.

The flotation procedure may be further enhanced by controlling the pressure of the slurry entering the flotation cells. The outlet pressure of the hydraulic microniser is controlled to provide slurry at pressure to the flotation cells thereby further utilising the pressure energy of the slurry for the generation of bubbles as in jet-based flotation devices.

The flotation process of the second aspect of the invention can be further enhanced by the addition of surfactants (eg hydrocarbons such as diesel) either before or after the hydrothermal reactor, and/or by the addition of other gases (eg air).

After the micronising of the first aspect of the invention or flotation according to the second aspect, the clean coal may be partially dewatered. This can be achieved by a number of methods, including centrifuges and thickener/settlers.

The product coal may be further micronized in preparation for use in diesel engines or other combustion devices, if required.

The efficiency of flotation and dewatering may be advantageously improved by controlling the hydrothermal treatment conditions to control the hydrophobic properties of the coal surfaces. Increased temperature will increase the release of organics, which will preferentially coat the coal particles and increase their hydrophobicity.

In an alternative embodiment of the second aspect of the invention, the flotation procedure is a reverse flotation in which the mineral and/or inorganic content is floated, and flotation of the coal is suppressed as a result of humic acids formed during said heating under pressure.

In this alternative embodiment, the humic acids reduce the natural hydrophobicity of the hydrothermally treated coal, thereby suppressing coal flotation and allowing selective flotation of the mineral and/or inorganic components. Reagents would typically be added to render the mineral surfaces more hydrophobic, for example dodecyltrimethyl ammonium bromide. In conventional or forward flotation, reagents such as diesel or kerosene are used to render the coal surface hydrophobic.

In this alternative embodiment only a small proportion of material (the mineral components) needs to be removed from the hydrothermally treated coal water slurry, which reduces reagent consumption, flotation air (or other gases) and energy consumption needed to perform the flotation separation process.

By not increasing the hydrophobicity of the coal, the coal particles are also less likely to flocculate, which has the added benefit of reducing the viscosity of the resulting coal water fuel slurry. This will assist atomization where the fuel is injected into diesel engines or burners, or allow a higher solids loading for a given viscosity.

As used herein, except where the context requires otherwise the term “comprise” and variations of the term, such as “comprising”, “comprises” and “comprised”, are not intended to exclude other additives, components, integers or steps.

### BRIEF DESCRIPTION OF THE DRAWINGS

The invention will now be further described by way of example only with reference to accompanying drawings, in which:

FIG. 1 is a schematic of a conventional hydrothermal dewatering process for partial dewatering of low rank coal;

FIG. 2 is a schematic of a hydrothermal treatment apparatus and process according to an embodiment of the first aspect of the invention;

FIG. 3 is a schematic of a hydrothermal treatment apparatus and process according to an embodiment of the second aspect of the invention;

FIG. 4 is a similar view depicting an alternative embodiment of the second aspect of the invention; and

FIG. 5 is a schematic of a process incorporating both aspects of the invention.

### PREFERRED EMBODIMENTS OF THE INVENTION

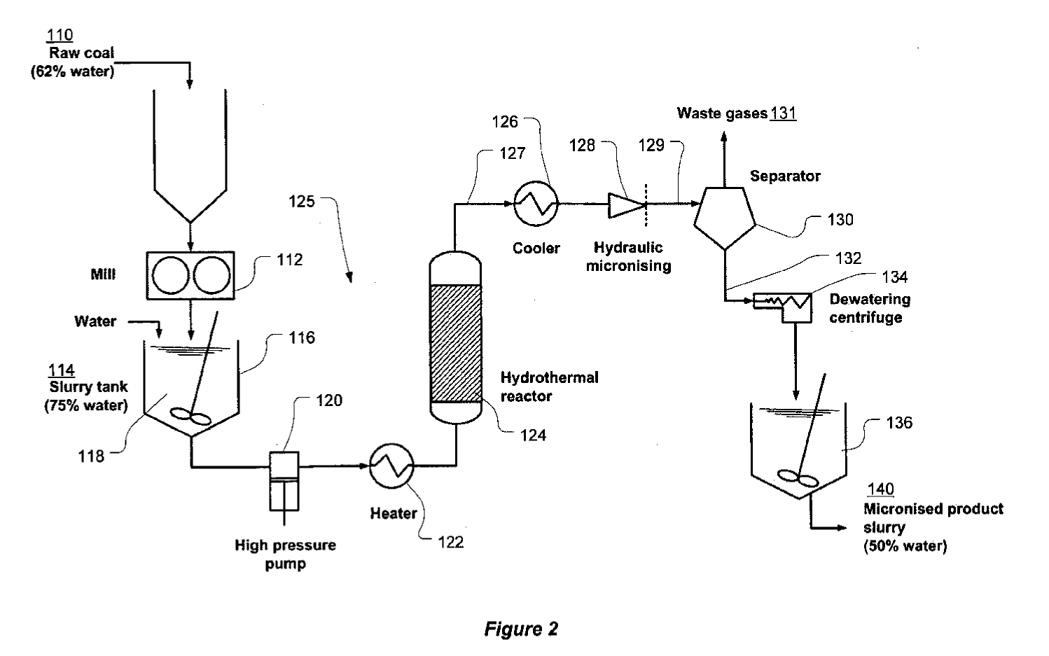

In the exemplary process of the invention depicted schematically in FIG. 2, low rank coal 110, for example a brown coal or lignite, of 62% water content, is processed in a mill 112 to a size typically of −1 mm. The thus prepared particulate coal is passed to a slurry tank 116 in which the coal is mixed with water 114 to produce a pumpable slurry 118 which is, for example, 75% water. The slurry is drawn from tank 116 by a high pressure pump 120 and passed through a heater 122 to a hydrothermal reactor 124, which may, for example, be an autoclave. Here, in accordance with conventional hydrothermal treatment, the coal slurry is retained in a heated state at a temperature in the range at 250-350° C. and at a pressure above the saturation pressure whereby the water released from the coal does not boil, for 20-30 minutes. Pump 120, heater 122 and reactor 224 together constitute a hydrothermal reactor arrangement 125. The process of hydrothermal treatment causes a number of dehydration and decarboxylation reactions to occur in the coal, which at least partially releases or liberates (chemically) bound water and some carbon dioxide (via the decomposition of hydroxide and carboxyl groups).

The hydrothermally treated slurry 127 is cooled 126 and then passed to a hydraulic jet mill 128 in which the high pressure slurry water is controllably released, effecting controlled pressure reduction, and employed to hydraulically micronise the coal particles of the slurry.

The depressurised slurry 129 exiting the jet mill 128 thereby entrains micronised coal particles, i.e. coal in which >80% will pass through a 40 μm sieve.

Other particles of the slurry, e.g. mineral and inorganic particles, may be milled to a lesser extent, if at all.

Thereafter, the process is conventional. The gases evolved during the treatment, primarily carbon dioxide, are removed in a gas separator 130 and sent to waste 131. The slurry fraction 132 is passed through a centrifuge 134 and thickeners 136 to achieve a micronised product slurry 140 having approximately 50% water.

The insertion of the hydraulic micronising step 128 is effective in reducing the energy consumption for the overall process by an estimated 40 kWh/t coal (on a dry basis) and to reduce the further micronising otherwise required downstream. At the particular stage in the process illustrated in FIG. 2, the hydraulic micronising step 128 enhances the liberation of mineral matter due to the high sheer and hydraulic forces acting on the particles, together with shock and cavitation effects, which enhances the effectiveness of subsequent cleaning steps.

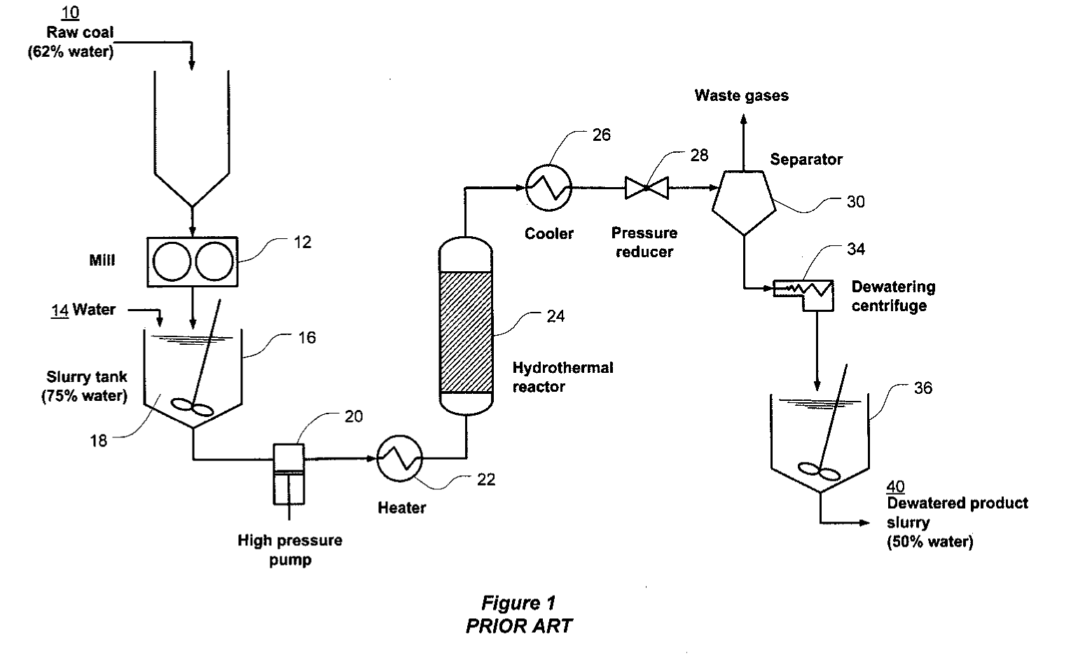

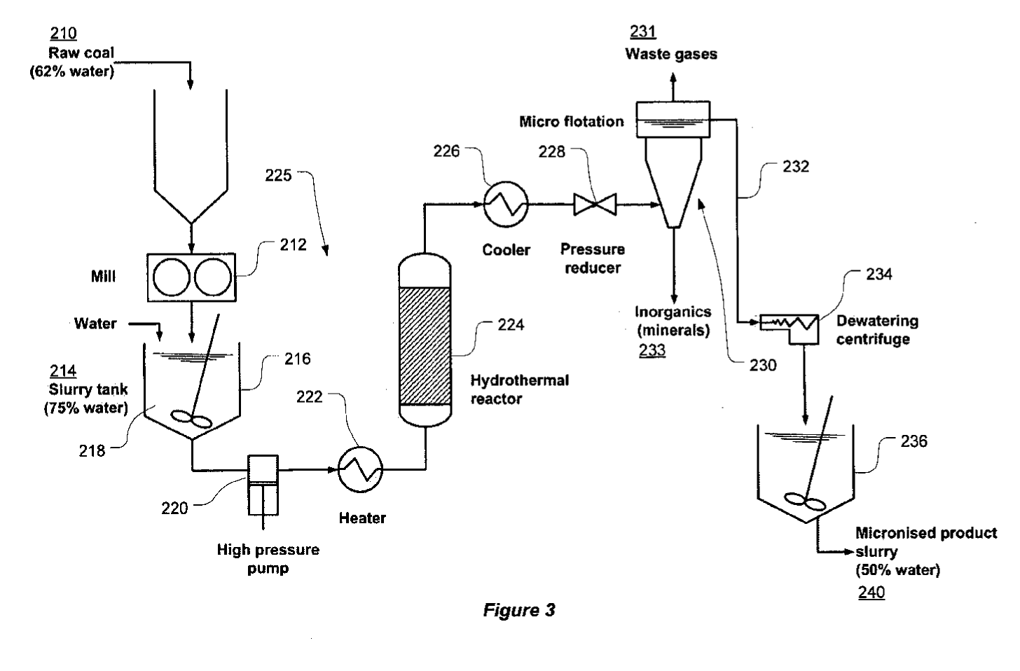

FIG. 3 illustrates an alternative modification of the conventional scheme of FIG. 1, according to the second aspect of the invention.

Low rank coal 210, for example a brown coal or lignite of 62% water content, is processed in a mill 212 to a size typically of −1 mm. The thus prepared particulate coal is passed to a slurry tank 216 in which the coal is mixed with water 214 to produce a pumpable slurry 218 which is, for example, 75% water. The slurry is drawn from tank 216 by a high pressure pump 220 and passed through a heater 222 to a hydrothermal reactor 224, whilst may, for example, for an autoclave. Here, in accordance with conventional hydrothermal treatment, the coal slurry is retained at 250-350° C. and at a pressure above the saturation pressure, whereby the water released from the coal does not boil, for 20-30 minutes. Pump 220, heater 222 and reactor 224 together constitute a hydrothermal reactor arrangement 225. The process of hydrothermal treatment causes a number of dehydration and decarboxylation reactions to occur in the coal, which at least partially liberates (chemically) bound water and some carbon dioxide (via the decomposition of hydroxide and carboxyl groups).

As in the conventional process, the slurry is cooled 226 and slurry pressure is reduced in pressure reduction device 228. The subsequent stage is conventionally a separator (30 in FIG. 1) for removing waste gases, primarily carbon dioxide, evolved during the process by the abovementioned decarboxylation reactions. In accordance with the second aspect of the invention the separator 230 is provided as a floatation separator in which the carbon dioxide and minor other gases retained in the slurry are employed to provide enhanced separation of the coal from the mineral matter using the fine bubbles caused by controlled evolution of the dissolved gases.

The rate of gas, especially CO₂, evolution can be determined by controlling the temperature of flotation, flotation cell depth, flotation cell overpressure, together with ultrasonics and other techniques used to stimulate nucleation of gas bubbles in liquids: the principles of these techniques are known to those skilled in the art of flotation separation.

Typically, the flotation separator 230 has plural flotation cells. The flotation procedure may be further enhanced by controlling the pressure of the slurry entering the flotation cells, through controlled management of pressure reducer 228 in conjunction with the flotation cells.

The slurry fraction 232 containing the floated coal recovered from separator 230 is passed through a centrifuge 234 and thickeners 236 to achieve a micronised product slurry 240 having approximately 50% water. Gases, primarily CO₂, recovered from flotation separator 230 go to waste 231 while the mineral and/or inorganic content forms the recovered solid residue 233.

If necessary to facilitate the selective flotation of the coal particle fraction, reagents such as diesel or kerosene may be employed to render the coal surfaces hydrophobic. Moreover, as earlier mentioned, the efficiency of flotation dewatering may be advantageously improved by controlling the hydrothermal treatment conditions to control the hydrophobic properties of the coal surfaces. Increased temperature will increase the release of organics, which may preferentially coat the coal particles and increase their hydrophobicity.

Partially removing mineral constituents will also increase the calorific value of the coal relative to that which would be produced from the untreated coal for a given slurry water content.

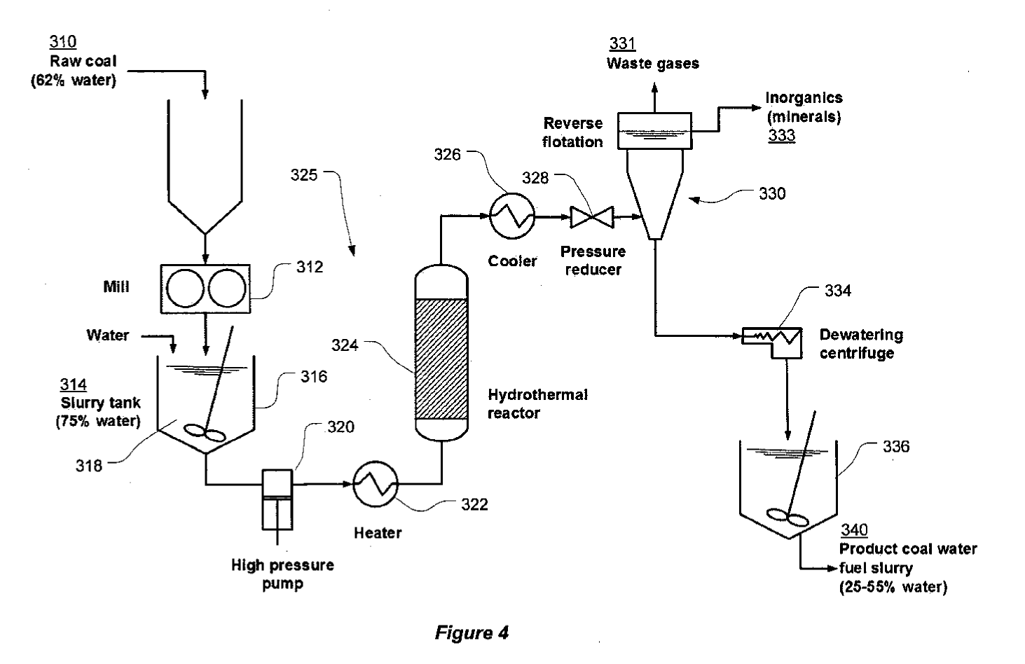

FIG. 4 illustrates an alternative scheme particularly suitable for low rank coals such as Victorian brown coals or Indonesian or German lignites. In this case, the flotation separator 330 downstream of pressure reducer 328 is operated as a reverse flotation procedure by taking advantage of the humic acids formed from the low grade coal during the hydrothermal step in reactor 324. Humic acids reduce the natural hydrophobicity of the hydrothermally treated coal, thereby suppressing coal flotation and allowing selective flotation of the mineral and/or inorganic components. Typically, reagents are added to render the mineral and/or inorganic surfaces more hydrophobic: one such reagent that may be applicable is dodecyltrimethyl ammonium bromide. In this arrangement, only a small proportion of material, the mineral and/or inorganic components, needs to be removed from the hydrothermally treated coal water slurry (in contrast to the major solid component, the coal, in the forward flotation scheme of FIG. 3), which reduces overall reagent consumption, flotation gas and energy consumption needed to be perform the flotation separation process.

A further benefit with the scheme of FIG. 4 is that the coal particles, being less hydrophobic, are less likely to flocculate, which has the added benefit of reducing the viscosity of the resulting coal water slurry. If the slurry is employed downstream as a fuel for diesel engines or burners, this will assist atomisation, or allow a higher solids loading for a given viscosity.

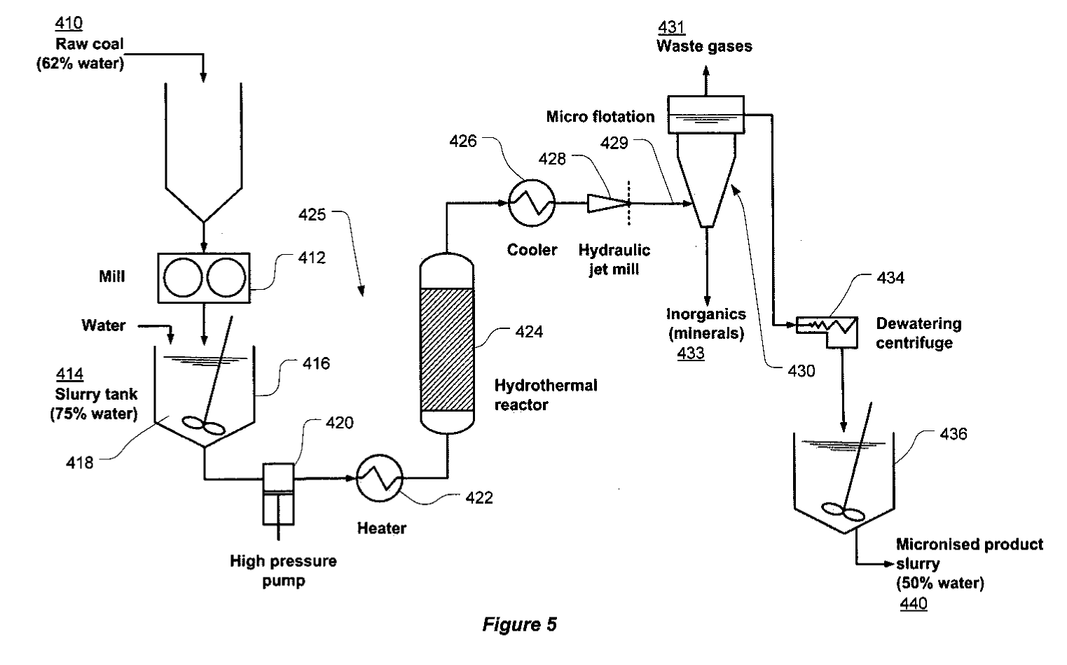

The two aspects of the invention can be beneficially employed together. Such a process is depicted in FIG. 5, in which like parts are indicated by numbers that are alike save for the first numeral, in this instance a 4. In this configuration, the micronised coal slurry 429 exiting the hydraulic jet mill 428 is fed directly to the flotation separator 430, which in this case employs forward flotation. The use of the hydraulic jet mill allows enhanced control of the outlet pressure of the hydraulic microniser to in turn provide slurry at pressure to the flotation cells and to utilise the pressure energy of the slurry for the generation of bubbles as in jet-based flotation devices.

It will be appreciated that a still further embodiment of the invention comprises a scheme similar to FIG. 5 that utilises both aspects of the invention but in which the flotation separator employs reverse flotation as depicted in FIG. 4.

By way of general overview, it is expected that the use of the first aspect of the invention without the second aspect would be especially applicable with low ash coals. Employment of flotation separation, that is the second aspect of the invention, alone without the first aspect would be appropriate where micronising is preferred after transportation of the slurry to the location of an engine, and when sufficient liberation of mineral constituents to enable cleaning by flotation occurs without micronising. In this case, as the pressure energy has not been employed to micronise the coal, more pressure energy is available from the slurry to energise the flotation.

The combined process utilising both aspects of the invention is appropriate when both micronising and cleaning of the coal is required.

As earlier foreshadowed, the coal water slurry obtained by the process of the invention, utilising either or both of its aspects, may be suitable as a fuel for diesel engines or other combustion devices such as boilers and kilns.

1-26. (canceled)

27. A process for treating coal in which coal, in the form of particles in an aqueous slurry, is heated under pressure to at least partially release bound water from the coal particles, the bound water being released as liquid water, wherein, after said heating under pressure, the coal particles of the slurry are hydraulically milled by means of the slurry water as the slurry pressure is reduced through the milling.

28. A process according to claim 27 wherein the slurry after cooling and said hydraulic milling is treated to separate out at least a portion of the total liquid water of the slurry,

29. A process according to claim 27 wherein the coal particles of the slurry are micronized by the hydraulic milling.

30. A process according to claim 27 wherein the slurry of coal particles is adaptable as a fuel for a diesel engine.

31. A process according to claim 27 wherein said heating and pressure also releases gases from the coal particles, and wherein mineral and/or inorganic content is separated from the slurry by a flotation procedure that utilises bubbling of released gases following reduction of the slurry pressure.

32. A process according to claim 31 wherein the released gases are primarily CO₂.

33. A process according to claim 31 including controlling the slurry pressure to optimise the flotation procedure.

34. A process according to claim 31 wherein the flotation procedure is effective to float the coal.

35. A process according to claim 31 wherein the flotation procedure is a reverse flotation in which the mineral and/or inorganic content is floated, and flotation of the coal is suppressed as a result of humic acids formed during said heating under pressure.

36. A process according to claim 31 wherein the coal is a low rank coal such as brown coal or lignite.

37. Apparatus for treating coal, comprising:
a hydrothermal reactor arrangement for heating coal, in the form of particles in an aqueous slurry, under pressure to at least partially release bound water from the coal particles, the bound water being released as liquid water, and
hydraulic mill means to receive the slurry from the hydrothermal reactor and to hydraulically mill the coal particles of the slurry by means of the slurry water as the slurry pressure is reduced through the mill means.

38. Apparatus according to claim 37 further including means to cool the slurry and means downstream of said cooling means and of said hydraulic mill means to separate out at least a portion of the total liquid water of the slurry.

39. Apparatus according to claim 37 wherein said hydraulic mill means is effective to micronise the coal particles.

40. Apparatus according to claim 37 further including a flotation separator to receive the slurry of hydraulically milled coal and to separate mineral and/or inorganic content from the slurry by a flotation procedure that utilises bubbling of gases following reduction of the slurry pressure, which gased were released from the coal particles in said hydrothermal reactor arrangement.

41. Apparatus according to claim 37 wherein said hydraulic mill means is a hydraulic jet mill.

42. A process for treating coal in which the coal, in the form of particles in an aqueous slurry, is heated under pressure to at least partially release gases and bound water from the coal particles, the bound water being released as liquid water, wherein, after said heating under pressure, mineral and/or inorganic content is separated from the slurry by a flotation procedure that utilises bubbling of said released gases following reduction of the slurry pressure.

43. A process according to claim 42 wherein the slurry after cooling and said flotation procedure is treated to separate out at least a portion of the total liquid water of the slurry.

44. A process according to claim 42 wherein the flotation procedure is effective to float the coal.

45. A process according to claim 42 wherein the released gases are primarily CO₂.

46. A process according to claim 42 wherein the flotation procedure is a reverse flotation in which the mineral and/or inorganic content is floated, and flotation of the coal is suppressed as a result of humic acids formed during said heating under pressure.

47. A process according to claim 42, including controlling the slurry pressure to optimise the flotation procedure.

48. A process according to claim 42 wherein the coal is a low rank coal such as brown coal or lignite.

49. Apparatus for treating coal, comprising:
a hydrothermal reactor arrangement for heating coal, in the form of particles in an aqueous slurry, under pressure to at least partially release gases and bound water from the coal particles, the bound water being released as liquid water; and
a flotation separator to receive the slurry from the hydrothermal reactor rearrangement and to separate mineral and/or inorganic content from the slurry by a flotation procedure that utilises bubbling of said released gases following reduction of the slurry pressure.

50. Apparatus according to claim 49 further including means to cool the slurry and means downstream of said cooling means and of said flotation separator to separate out at least a portion of the total liquid water of the slurry.

51. Apparatus according to claim 49 wherein the flotation separator is configured to float the coal.

52. Apparatus according to claim 49 wherein the flotation separator is configured for reverse flotation in which the mineral and/or inorganic content is floated, and flotation of the coal is suppressed as a result of humic acids formed during said heating under pressure.

53. A process according to claim 31 wherein the slurry of coal particles is adaptable as a fuel for a diesel engine.

54. A process according to claim 35 wherein the slurry of coal particles is adaptable as a fuel for a diesel engine.
